(19) United States
(12) Patent Application Publication
(10) Pub. No.: US 2010/0208402 A1
(43) Pub. Date: Aug. 19, 2010

(54) Current transformer type power controller

(76) Inventor: Hsien-Meng Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,267

(22) Filed: Feb. 18, 2009

(51) Int. Cl. H02H 9/08

(52) U.S. Cl. 361/93.9

(57) ABSTRACT

A current transformer type power limit controller is disclosed having a current transformer connected in series to the load. The number of turns of the primary winding and secondary winding of the current transformer are in ones place and thousands place respectively. The current transformer amplifiers voltage signal to charge capacitors through a voltage doubler circuit for the working of a detection and trigger circuit and a relay that switches off the load when the power consumed surpasses the set value (190W). The current transformer type power limit controller further includes a hold circuit, an error correction circuit, and a detection and trigger circuit.

### BACKGROUND OF THE INVENTION

1. Field of the Invention

The present invention relates to power control technology and more particularly, to a current transformer type power limit controller.

2. Description of the Related Art

The U.S. Department of Energy established test procedures and energy conservation standards for ceiling fans and ceiling fan light kits per the Energy Policy Act of 2005 (EPACT 2005). On Jan. 1, 2009 important new standards went into effect, requiring that light bulbs be included in the manufacturer's carton and that light kits operate with no more than 190 watts total.

A conventional power limit controller is known comprising a power resistor connected to the load, an operation amplifier, and a CPU. The operation amplifier makes comparison and computing. The CPU runs the control. The use of the operation amplifier and the CPU greatly increases the cost and the device size. During operation, the power limit controller releases a big amount of heat. Further, this design of power limit controller is not easy to install and provides low safety level. For reset, the main power must be switched off.

### SUMMARY OF THE INVENTION

The present invention has been accomplished under the circumstances in view. It is one object of the present invention to provide a current transformer type power limit controller, which saves power consumption and releases less amount of heat during operation. It is another object of the present invention to provide a current transformer type power limit controller, which allows quick reset without switching off main power.

To achieve these and other objects of the present invention, the current transformer type power limit controller has a current transformer connected in series to the load. The number of turns of the primary winding and secondary winding of the current transformer are in ones place and thousands place respectively. The current transformer amplifiers voltage signal to charge capacitors through a voltage doubler circuit for the working of a detection and trigger circuit and a relay that switches off the load when the power consumed surpasses the set value (190W). The current transformer type power limit controller further includes a hold circuit, an error correction circuit, and a detection and trigger circuit.

### BRIEF DESCRIPTION OF THE DRAWINGS

The FIGURE is a circuit diagram of a current transformer type power limit controller in accordance with the present invention.

### DETAILED DESCRIPTION OF THE PREFERRED EMBODIMENT

Referring to the annexed drawing of the FIGURE, a current transformer type power limit controller in accordance with the present invention is shown comprising a hold circuit 10, a relay 11, a current transformer 12, a voltage doubler circuit 13, an error correction circuit 14, and a detection and trigger circuit 15.

The hold circuit 10 comprises a resistor R1 and a rectifier diode D1. The voltage doubler circuit 13 comprises rectifier diodes D2 and D3, and capacitors C1 and C2. The error correction circuit 14 comprises resistors R2 and RX1. The detection and trigger circuit 15 comprises a zener diode Z1, and a silicon-controlled rectifier SCR.

When electrically connected, electricity goes through the load (lamp or ceiling fan and lamp assembly), the normal-close contact B and contact C of the relay 11 and the primary side of the winding, of the current transformer 12, thereby turning on the load.

When the power is under the set value (for example, 190W), the primary winding and secondary winding of the current transformer 12 amplify the current signal, increasing voltage to 15˜20V while the current is maintained at 1 milliampere. At this time, the AC voltage outputted by the secondary winding of the current transformer 12 is rectified by the rectifier diodes D2 and D3 into 30˜40V that is stored in the capacitors C1 and C2 of the voltage doubler circuit 13. The voltage at the capacitor C2 is shunt-controlled by the resistors R2 and RX1 of the error correction circuit 14 to the level below the detection limit of the zener diode Z1 of the detection and trigger circuit 15, and therefore the relay is maintained at on state.

In case of an overcurrent, the output voltage of the secondary winding of the current transformer 12 rises, causing the zener diode Z1 of the detection and trigger circuit 15 to be electrically connected, and therefore the silicon-controlled rectifier SCR is electrically connected. When the silicon-controlled rectifier SCR is electrically connected, the contact C is disconnected from the normal-close contact B of the relay 11 and electrically connected to the normal-open contact A. During the delay time where the transient contact C is disconnected from the normal-close contact B of the relay 11 and electrically connected to the normal-open contact A, only tile capacitors C1 and C2 provide electricity. Therefore, when the contact C is disconnected from the normal-close contact B of the relay 11, the resistor R1 and rectifier diode D1 of the hold circuit 10 start to work. When the normal-open contact A is electrically connected, let the relay 11 keep sucking up the contact C, and therefore the power-off state is maintained. At this time, the capacitors C1 and C2 are completely discharged. When wishing to have the load resume working, turn off power supply, or lower the voltage where a remote control or light control is used. This operation is quite simple, achieving power-limit and power-saving functions.

Referring to the FIGURE again, the hold circuit 10 comprises a resistor R1 and a rectifier diode D1; the relay 11 is a 24V relay; the number of turns of the primary winding and secondary winding of the current transformer 12 are in ones place and thousands place respectively, however only 1 milliampere is necessary; the voltage doubler circuit 13 comprises rectifier diodes D2 and D3 and capacitors C1 and C2; the error correction circuit 14 comprises resistors R2 and RX1; the detection and trigger circuit 15 comprises a zener diode Z1 and a silicon-controlled rectifier SCR.

During normal operation (power used is below 190W):

External 120V AC power supply is connected to the load, the normal-close contact B of the relay 11 and the primary side and grounding line of the current transformer 12, forming a loop. At this time, the primary winding and secondary winding of the current transformer 12 amplify the current signal and the voltage, enabling the rectifier diodes D2 and D3 of the voltage doubler circuit 13 to rectify powder into 30˜40V for charging the capacitors C1 and C2. When the power used is under the set value (190W), the shunt voltage of the resistors R2 and RX1 is below the voltage of the zener diode Z1 of the detection and trigger circuit 15. At this time, the zener diode Z1 is off and the silicon-controlled rectifier SCR is not triggered, and therefore the relay 11 is maintained at on-state.

When surpassed the set power (190W), the output voltage of the secondary winding of the current transformer 12 rises. At this time, the shunt voltage of resistors R2 and RX1 surpasses the voltage of the zener diode Z1, and the zener diode Z1 is electrically connected to trigger the silicon-controlled rectifier SCR, causing the relay 11 to suck up, and therefore the normal-open contact A is closed and the normal-close contact B is opened. During this stage, the hold circuit 10 provides the relay 11 with the necessary working voltage, holding the normal-close contact B at off-state and the normal-open contact A at on-state. In the application of a remote control or light control, when the load is lowered to the condition where the relay 11 reaches the release voltage, the relay 11 is released, thus reset is done to have the normal-close contact B be electrically connected without switching off main power.

As stated above, the current transformer type power limit controller has the advantages of power-saving during standby mode, low heat, high heat resistance, accurate and rapid control, high safety without supplementary power supply, quick reset without switching off main power.

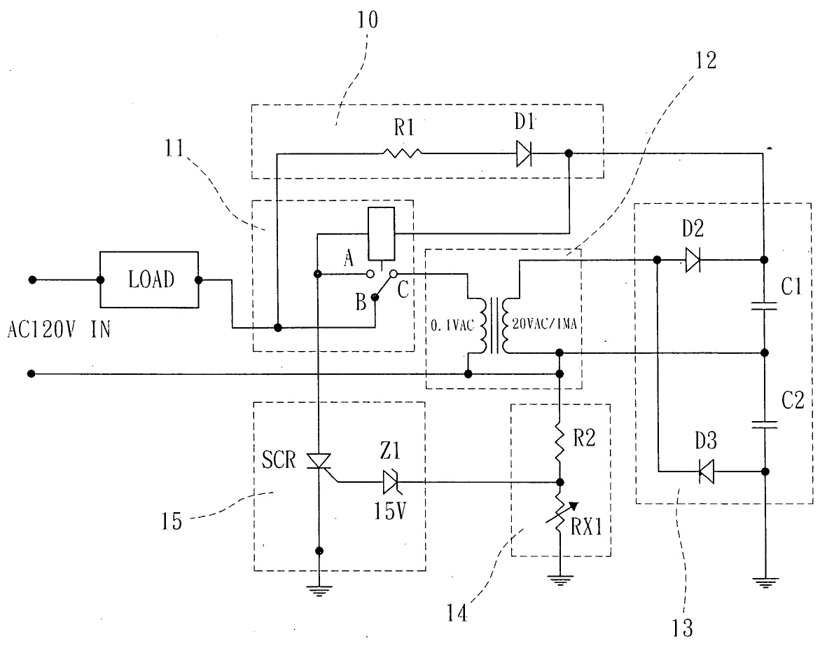

A prototype of current transformer type power limit controller has been constructed with the features of FIG. 1. The current transformer type power limit controller functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A current transformer type power limit controller, comprising: a hold circuit, a relay, a current transformer, a voltage doubler circuit, an error correction circuit, and a detection and trigger circuit, wherein:
said hold circuit comprises a resistor and a rectifier diode;
said relay is electrically connected to said silicon-controlled rectifier of said detection and trigger circuit and said hold circuit, having the normal-close contact thereof connected to the load;
said voltage doubler circuit comprises two rectifier diodes and two capacitors that are chargeable to provide said relay with the necessary working voltage;
said error correction circuit comprises two resistors;
said detection and trigger circuit comprises a zener diode and a silicon-controlled rectifier, said zener diode being adapted to detect the current and voltage of the load;
when the power of the load drops below a predetermined set value, said current transformer outputs an AC voltage through the rectifier diodes of said voltage doubler circuit to charge said two capacitors and to hold said relay at the normal-close contact B so that the voltage shunt through the resistors of said error correction circuit is below the voltage value of said zener diode, and the load functions normally;
when said zener diode of said detection and trigger circuit detects an overcurrent, said silicon-controlled rectifier is electrically connected, causing the normal-open contact A of said relay to be off and said relay is maintained at off-state by said hold circuit.
